(19) United States
(12) Patent Application Publication
(10) Pub. No.: US 2009/0212964 A1
(43) Pub. Date: Aug. 27, 2009

(54) Electrical Test Apparatus

(76) Inventors: Rodney Hibma, Golden, CO (US); Ammon Balaster, Boulder, CO (US); Jeffrey Buske, Larkspur, CO (US); Robert Lee, Golden, CO (US)

Correspondence Address: JACKSON ESQUIRE;ROGER A. JACKSON, 209 KALAMATH STREET, UNIT 9, DENVER, CO, 80223-1348, US

(21) Appl. No.: 12/390,460

(22) Filed: Feb. 21, 2009

Related U.S. Application Data
(60) Provisional application No. 61/066,477, filed on Feb. 21, 2008.

(51) Int. Cl. G08B 21/00

(52) U.S. Cl. 340/657

(57) ABSTRACT

Broadly, the present invention is an electrical test apparatus that is adapted to be removably engaged and in electrical communication with an electrical power terminal, the electrical test apparatus includes analytical circuitry that is operative in each of a plurality of modes to monitor the electrical power terminal and produce a plurality of event marker signals. Further included is a criterion circuitry that is operative in each of the plurality of modes to receive each of the plurality of event marker signals for a comparison with a selected value for each of the plurality of modes, wherein the criterion circuitry outputs a plurality of indicator signals each corresponding to one of the plurality of modes. In addition, a structure is included for producing an associated perceptible output in response to each of the plurality of indicator signals.

### RELATED PATENT APPLICATION

This application claims priority from U.S. provisional patent application Ser. No. 61/066,477 filed Feb. 21, 2008 by Rodney Hibma, Robert Lee, Ammon Balaster, and Jeffrey Buske.

### TECHNICAL FIELD

The present invention generally pertains to the field of electrical circuit test apparatus and more particularly to a portable plug-in electrical power line test module electrical circuit tester, including a power line analyzer with the electrical test apparatus adapted to removably engage a common electrical power receptacle. Test examples would include to analyze power line voltages, neutral, and ground circuit conditions, line frequency, phase rotation, as well as providing data logging and circuit tracing functions, ground fault circuit interrupter functions, in addition to remote digital oscilloscope functions as a few typical testing and recording examples.

### BACKGROUND OF INVENTION

Portable electrical power analyzers exist in many sizes and shapes and are typically having a single test function or have a relatively few test functions available while having numerous adaptive interfaces with the circuit to be tested such as clips prongs, probes, plugs, and the like. The typical electrical power receptacles are found throughout households, commercial, and industrial locations. Further, every room in a household or commercial location is provided with multiple receptacles so as to minimize the need for extension cords and adapters that enable multiple loads to be run through a single receptacle in addition to the increased safety hazard of wires running all over like spaghetti that can cause tripping risk, wire tracing difficulties, unintended flux line interference, and the like. In industrial applications for example, high-power single and three phase power receptacles are used that utilize higher voltages and higher current (amp) levels when these circuits are “live”, resulting in an even greater risk of personal injury or fire risk do to the higher power levels having an explosive potential during a shorted circuit. Thus accurate testing after electrical circuit installation is very important, resulting in all electrical receptacles required to be tested to ensure proper wiring routing and grounding prior to the application of electrical power to the circuitry. More specifically, in order to meet local and national code requirements, each receptacle must have the proper polarity and must be properly grounded. In addition for proper operation of electrical equipment and to help prevent costly damage to electrical equipment and the fire risk it is imperative that the quality and condition of the power at the receptacle remain within proper limit specifications.

Currently, to test for proper wiring, typically an electrician or an electrical inspector employs a simple receptacle testing device such as a Model # 61-500 made by the IDEAL.RTM company to ascertain if the receptacle is wired correctly. To test the condition of the power itself, more expensive multi-testers, both digital and analog are used. To test the condition of the electrical power with a multi-tester, electricians are required to probe multiple socket terminals of the power receptacle and make numerous voltage measurements. The probing and multiple measurements are difficult to complete in certain receptacle locations and these voltage measurements alone do not provide a complete analysis of the power or the circuit conditions. As an example, neutral and ground connections are often not tested due to inconvenience. In addition, power line frequency is not tested and rotation of three-phase circuits are also generally not tested. Intermittent power line faults such as power spikes, low voltage brown outs, or drop outs are often difficult to detect and diagnose. To detect these often illusive fault conditions expensive data loggers and oscilloscopes are used to track the condition of the electrical power being provided over a period of time.

In looking at the prior art in this area starting with United States patent application publication number 2008/0204034 to Blades discloses is an automated electrical wiring inspection system that enables an individual electrician to test every electrical wire, connection, outlet, switch, light, and appliance in a house, typically in a few hours or less. In Blades, the electrician attaches the device to the breaker panel or service panel, and then moves through the house, building, etc, turning power off and on. The system in Blades comprises a Portable Circuit Analyzer that is connected to the building's breaker panel. The circuit analyzer in Blades is in wireless communication with a hand-held computer device, such as a PDA, provided with custom software according to the invention. The circuit analyzer in Blades measures the resistance and length of each circuit established. When the testing process in Blades is completed, the PDA is enabled to generate a complete schematic diagram of the building, including, for example, an identification of the branch circuit to which each fixture, outlet, appliance, or other load or connection point is connected, see text page 2, paragraphs 17 and 18. The panel interface couples to a load center panel in Blades, for the purpose of mapping the entire building circuitry has a quite involved setup with numerous interfaces to connect, basically every single electrical outlet originating from a particular panel and primarily inducing a half wave rectified load to measure wire resistance with respect to ground.

Continuing in this area in the prior art in U.S. Pat. No. 7,259,567 to Sears et al. disclosed is an electrical outlet testing apparatus that can be connected to electrical outlets of various amperages, typically taught as 20, 30, and 50 amp circuits. The apparatus in Sears et al., includes an exterior body with a front and rear surface or panel, on the rear surface or panel, there is at least one electrical contact member for receiving an electrical signal when connected to the outlet. A processor unit in Sears et al., receives the signal and determines whether the outlet is wired correctly and producing quality electrical service, wherein quality electrical service means the outlet is producing the correct voltage and current. In Sears et al., depending on how the processor unit interprets the electrical signal, the condition of the outlet is displayed in a visual and audible format on the front surface or panel, see column 1, lines 39-55, with the typical indications being voltage, polarity, and open ground or neutral, wherein the ground integrity system utilizes capacitors in an unbalanced bridge using optoisolators that are in electrical communication with the capacitors.

Further, in the applicable prior art in U.S. Pat. No. 6,323,652 to Collier et al. disclosed is an electrical testing apparatus for determining the continuity between ground terminals of an electrical power extension cord and for determining the electrical grounding of an electrical power tool. The electrical testing apparatus in Collier et al., can also be configured to determining the proper polarity on each of the hot, negative, and ground cord wires of an electrical power extension cord. Each embodiment in Collier et al., generally comprises a plastic case housing one or more batteries which supplies power to a test button and the ground terminal of a female receptacle installed in the case, the one or more batteries are preferably 9 volt batteries, see Column 2, lines 66-67 and Column 3, lines 1-10. Next, in U.S. Pat. No. 6,734,682 to Tallman et al. disclosed is a testing apparatus for detecting and locating arc faults in an electrical system, wherein the typical arcing faults do not usually trip a typical circuit breaker, with the arcing faults caused by loose wire connections or terminations, worn wire insulation, and the like. Furthermore, the testing apparatus in Tallman et al., may be employed to locate electrical conductors and/or to detect one or more faults in an electrical system. Also, the testing apparatus in Tallman et al., may be used in combination with a pulsing device, which produces a periodic arcing signal to cause one or more of the arcing fault characteristics, in order to provide a testing system for detecting and locating an arcing fault in the electrical system, see column 1, lines 39-49. An annunciator speaker or display in Tallman et al., annunciates the responsive signal when the detector circuit is proximate to the arcing fault, in order to locate the arcing fault in the electrical system.

Yet further in the electrical test apparatus prior art in U.S. Pat. No. 6,933,712 to Miller et al. disclosed is an electrical circuit tracing and identifying apparatus and method. To reduce false-positive indications in Miller et al., some embodiments of the present invention transmit and receive a mid-range carrier frequency between 120 Hz and 3900 Hz, using a mid-range carrier frequency reduces coupling to adjacent circuits. Some embodiments in Miller et al., locate a carrier frequency between a pair of adjacent harmonics of the power line frequency, locating a carrier frequency between harmonics of the power line frequency mitigates the confusion receivers have in distinguishing between a transmitted signal and signals generated by other loads, also some embodiments use a time-variant filter. The time-variant filter in Miller et al., integrates over an integral number of power lines cycles to eliminate responses at harmonics of the power of the frequency and to reduce confusion between the transmitted signal and signals generated by other loads. To reduce errors due to erroneous calibration by the electrician in Miller et al., some embodiments of the present invention automatically compare the levels of received signals and by comparing received signal levels, the apparatus automatically calibrates itself. Some embodiments in Miller et al., implement a phase switching process, wherein phase switching helps to concentrate the spectral components of the transmitted signal about the carrier frequency, see column 3, lines 14-49.

What is needed is a receptacle tester that is simple and easy to use, being portable and of a single piece construction that can be plugged into a receptacle as easy as a lamp cord plug, wherein a more complete test diagnostics are performed than with a currently available basic voltage tester. Desired enhanced test diagnostics would include testing the condition of the power itself, such as neutral and ground connections, power line frequency, rotation of three-phase circuits, further additional desired testing would include intermittent power line faults such as power spikes, low voltage brown outs, or drop outs that are often difficult to detect and diagnose with time logging capabilities would be included in the single piece receptacle tester, without the need for the current expensive data loggers and oscilloscopes are used to track these illusive conditions of the electrical power being provided over a period of time. Thus, the ideal receptacle test apparatus would include all or a part of the previously mentioned testing capabilities, while at the same time be a small, lightweight, portable, and easy to use apparatus that can perform multiple testing functions. The resultant electrical test apparatus can be plugged into a power receptacle that includes electronic circuitry and a microprocessor to measure frequency, voltages across all lines, impedance neutral to ground, and display the resulting power condition and correct or incorrect wiring on a custom read-at-a-glance display by someone with minimal electrical power and circuitry knowledge, without the need to interpret various numerical readouts for determining acceptable electrical test results which requires specialized electrical power and circuitry knowledge and additional time.

Thus the desired electrical test apparatus may be plugged into a power receptacle that includes electronic circuitry and a microprocessor to measure frequency, voltages across all lines, impedance neutral to ground, and related parameters and display the resulting power condition and correct or incorrect wiring on a custom read-at-a-glance display. The electrical test apparatus includes interchangeable plug-in adapters so that the apparatus can be used with any power outlet. Also, a typical embodiment of the apparatus that includes a plurality of lights or LEDs that indicate correct or incorrect wiring of the outlet and may also indicate high or low voltage, incorrect ground connection, as well as rotation direction if used in three phase circuits, among other things. The electrical test apparatus may also include banana or other type jacks where leads can be plugged to easily connect each electrical terminal of the power outlet to function as a standard or custom electrical multi-meter for more detailed analysis.

### SUMMARY OF INVENTION

Broadly, the present invention is an electrical test apparatus that is adapted to be removably engaged and in electrical communication with an electrical power terminal, the electrical test apparatus includes analytical circuitry that is operative in each of a plurality of modes to monitor the electrical power terminal and produce a plurality of event marker signals. Further included is a criterion circuitry that is operative in each of the plurality of modes to receive each of the plurality of event marker signals for a comparison with a selected value for each of the plurality of modes, wherein the criterion circuitry outputs a plurality of indicator signals each corresponding to one of the plurality of modes. In addition, a structure is included for producing an associated perceptible output in response to each of the plurality of indicator signals.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a perspective view of the electrical test apparatus with the means for perceptible output facing frontward and the multiple prong connector facing rearward;

FIG. 2 shows an exploded perspective view of the electrical test apparatus with the housing separated from the multiple prong adapter;

FIG. 3 shows an exploded perspective view of the electrical test apparatus with the housing, adapter for the remote port, and the multiple prong adapter;

FIG. 4 shows a perspective view of the electrical test apparatus from the multi prong adapter side;

FIG. 5 shows an enlarged front elevation view of the means for producing the perceptible output that is adjacent to the housing second end portion;

FIG. 6 shows a summary schematic of the electrical test apparatus;

FIG. 7 shows an indicator table of the perceptible output in the form of a plurality of lights for the visual display in LED color indications for various electrical test conditions;

FIG. 8 shows a table of the National Electrical Manufacturers Association (NEMA) configurations for the electrical test apparatus for the single phase configurations;

FIG. 9 shows a detailed schematic of primarily the high voltage module with the multi prong connector interface with fuses, resistors, diodes, and associated circuitry;

FIG. 10 shows a detailed schematic of the power input circuitry;

FIG. 11 shows a detailed schematic of the analytical circuitry, the criterion circuitry, and the perceptible output;

FIG. 12 shows a detailed schematic of the battery power circuitry;

FIG. 13 shows a table of the connection definitions for NEMA test sequences L5, L6, L14, and L21;

FIG. 14 shows a printed circuit board layout portion of the electrical test apparatus;

FIG. 15 shows a perspective in use view of the electrical test apparatus with the multiple prong connector partially removably engaged to the electrical power receptacle for pictorial clarity; and

FIG. 16 shows a table of the National Electrical Manufacturers Association (NEMA) configurations for the electrical test apparatus for the three phase configurations.

### REFERENCE NUMBERS IN DRAWINGS

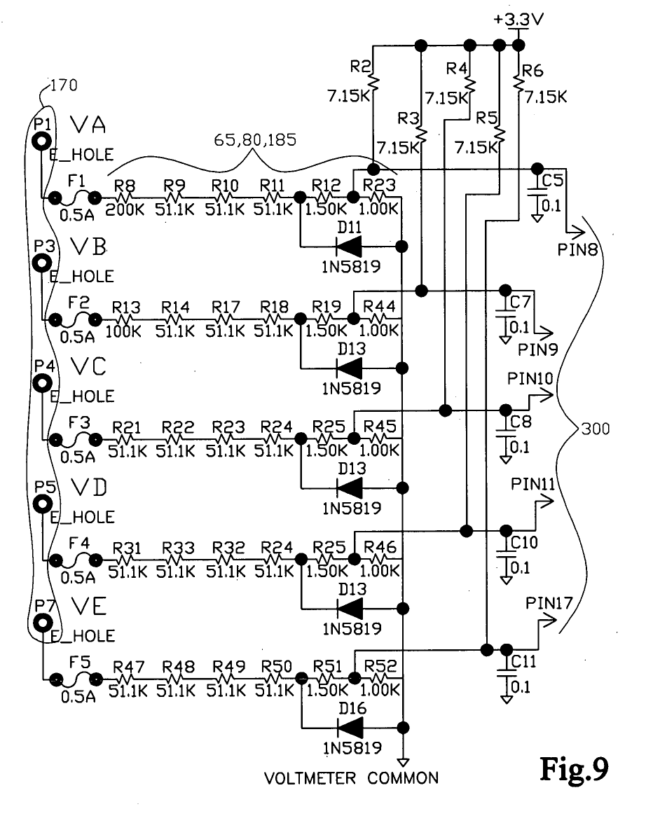

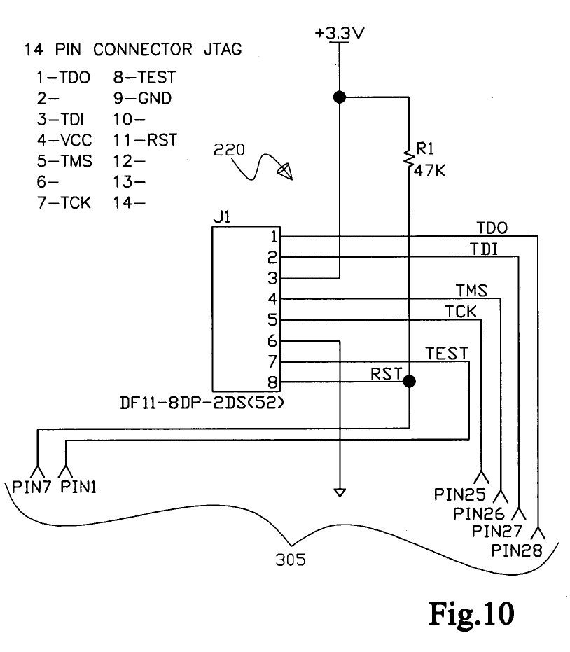

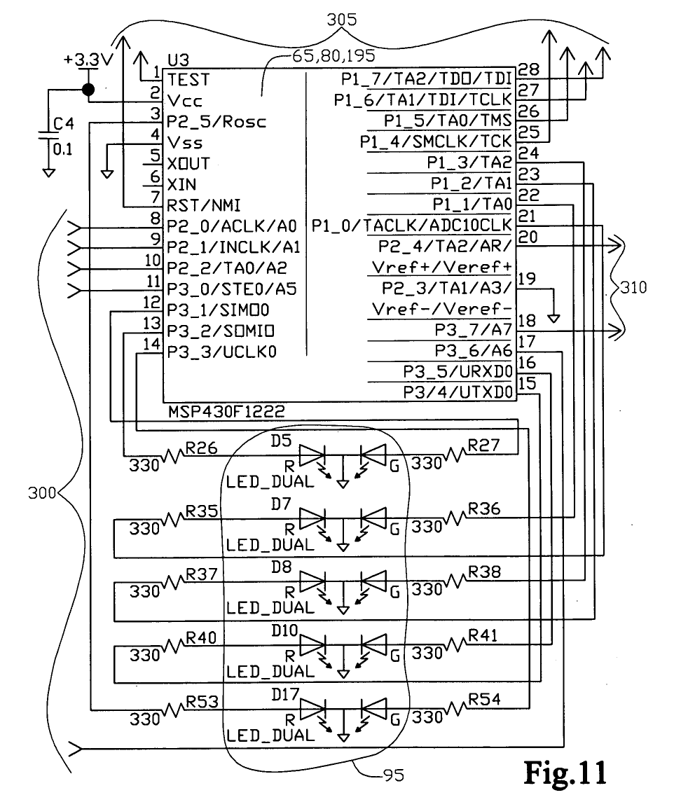

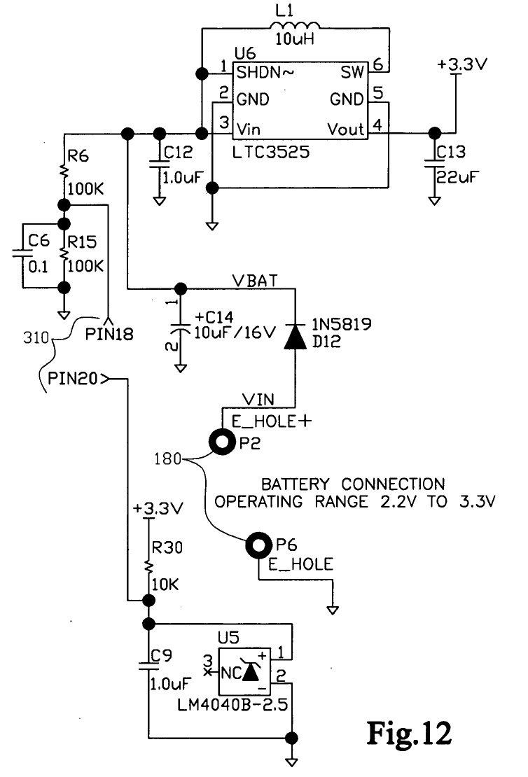

50 Electrical test apparatus
51 Electrical test apparatus alternative embodiment
55 Electrical power terminal
56 Electrical power receptacle
60 Adapted to be removably engaged and in electrical communication between the electrical test apparatus and the electrical power terminal
64 Analytical circuitry
65 Analytical circuitry alternative embodiment
70 Plurality of modes of the analytical circuitry
75 Event marker signals of the analytical circuitry
79 Criterion circuitry
80 Criterion circuitry alternative embodiment
85 Selected value of the criterion circuitry
90 Plurality of indicator signals of the criterion circuitry
94 Means for producing an associated perceptible output in response to each of the plurality of indicator signals
95 Means for producing an associated perceptible output in response to each of the plurality of indicator signals alternative embodiment
100 Voltage mode
105 Frequencies mode
110 Three phase circuit rotations mode
115 Ground conditions mode
120 Neutral conditions mode
125 Circuit tracers mode
130 Frequencies signals mode
135 Visual display of the means
140 Plurality of lights of the visual display
145 Unique color(s) of the plurality of lights
150 Selected audible perception of the means for perceptible output
155 Housing of the electrical test apparatus
160 First end portion of the housing
165 Second end portion of the housing
169 Multiple prong connector
170 Multiple prong connector alternative embodiment
171 Adapter for different multiple prong connections and the identification feature alternative embodiment
172 Adapter for the remote port
173 Means for a remote perceptible output alternative embodiment
174 Adapter for different multiple prong connections and the identification feature
175 Logging circuitry/memory alternative embodiment
176 Logging circuitry/memory
177 Means for a remote perceptible output
179 Energy source/storage power circuitry
180 Energy source/storage power circuitry alternative embodiment
184 High voltage module
185 High voltage module alternative embodiment
189 Analog/digital convertor
190 Analog/digital convertor alternative embodiment
195 Programmable chip
200 Plurality of unique multiple prong groups
205 Pin and sleeve type multiple prong connector
210 Means for electrical test apparatus activation/deactivation that is operational based upon proximity of said first end portion to said electrical receptacle
215 Remote port
220 Power input circuitry
300 Schematic interconnect from FIG. 9 to 11
305 Schematic interconnect from FIG. 10 to 11
310 Schematic interconnect from FIG. 11 to 12
500 Nominal less than 10% LED indication Red
500 Transient less than greater than 100% LED indication Red Blue
501 Nominal greater than 10% LED indication Red
501 Nominal greater than 0.25% LED indication Red flashing
501 Transient greater than 100% LED indication Red Blue
505 Nominal−7% LED indication Amber/yellow
506 Nominal+7% LED indication Amber/yellow
510 Nominal+/−4% LED indication Green
530 Nominal less than 0.1% LED indication Red
530 Nominal less than 0.25% LED indication Red flashing
535 Nominal−0.5 to 0.1% LED indication Amber/yellow
536 Nominal+/−0.05% LED indication Green
537 Nominal+0.5 to 0.1% LED indication Amber/yellow
538 Nominal greater than 0.1% LED indication Red
538 Nominal greater than 0.25% LED indication Red flashing
552 100 Vac
553 115 Vac
554 230 Vac
555 360 Vac
556 480 Vac
557 600 Vac
558 out of range
571 Transient less than greater than 100% LED indication Red alternate Blue
571 Nominal greater than 10% LED indication Red
571 Nominal greater than 0.25% LED indication Red flashing
572 Nominal+7% LED indication Amber/yellow
573 Nominal+/−4% LED indication Green
574 Nominal−7% LED indication Amber/yellow
575 Nominal less than 10% LED indication Red
575 Transient greater than 100% LED indication Red alternate Blue

### DETAILED DESCRIPTION

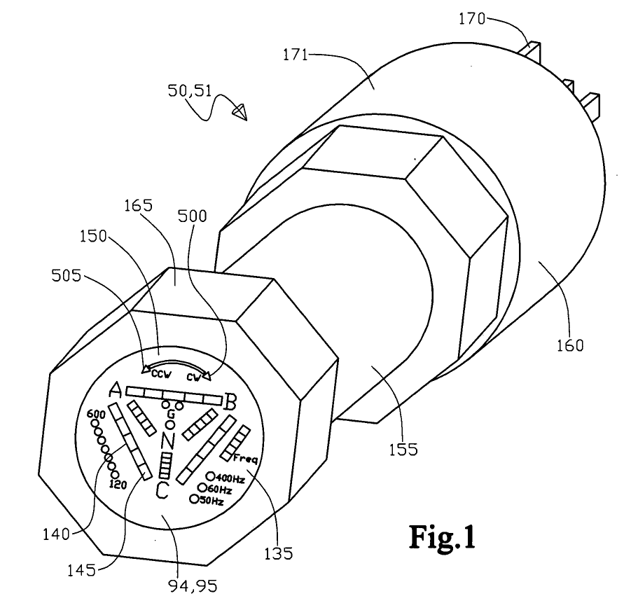

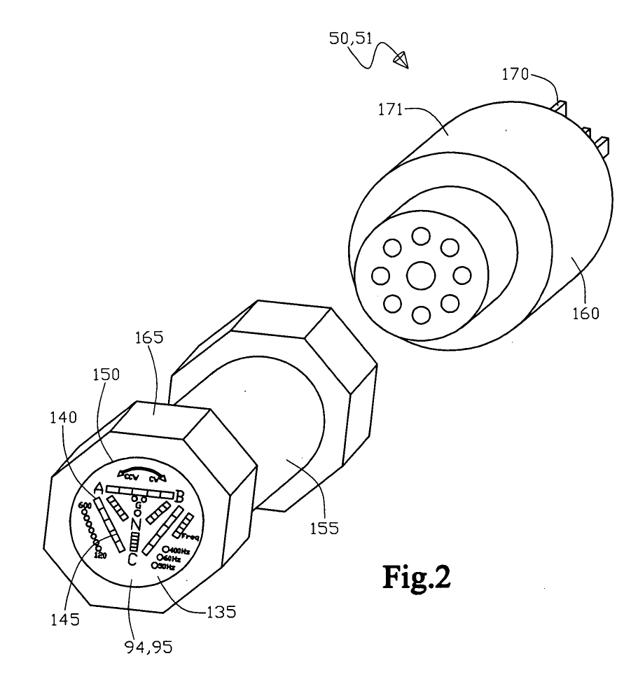

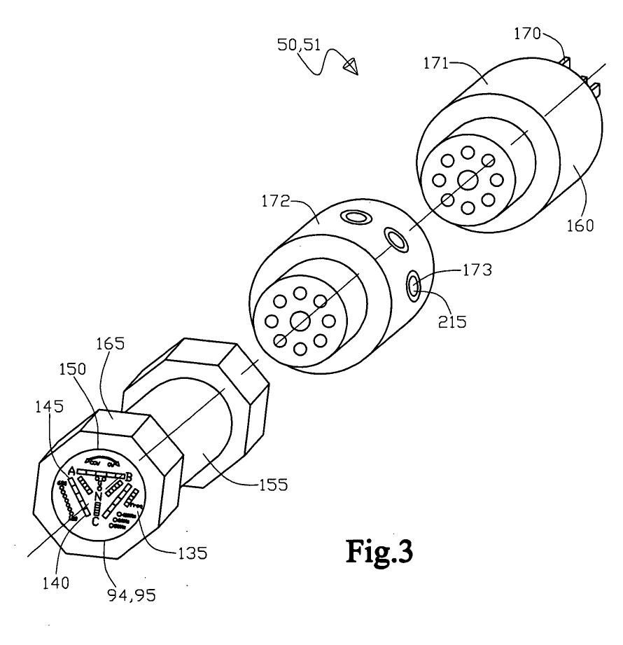

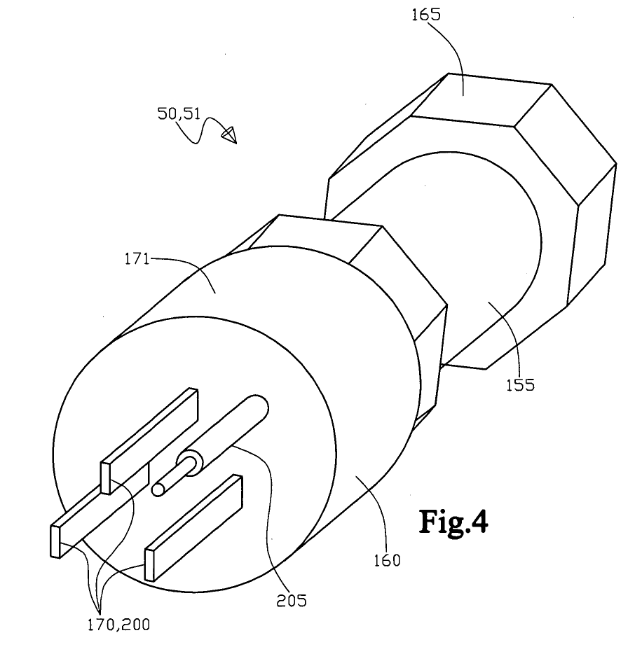

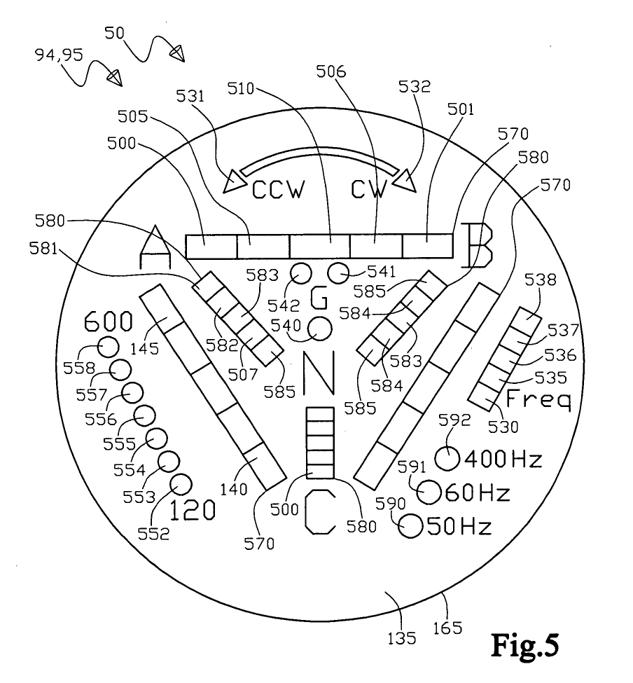

With initial reference to FIG. 1 shown is a perspective view of the electrical test apparatus 50 with the means 95 for perceptible output facing frontward and the multiple prong connector 169 or 170 facing rearward, note also that the housing 155 with a simplified display means 95 as applied to the alternative embodiment 51 is shown and FIG. 2 shows an exploded perspective view of the electrical test apparatus 50 or 51 with the housing 155 separated from the multiple prong adapter 171. Continuing, FIG. 3 shows an exploded perspective view of the electrical test apparatus 50 or 51 with the housing 155, adapter for the remote port 215, and the multiple prong adapter 171 and FIG. 4 shows a perspective view of the electrical test apparatus 50 or 51 from the multi prong adapter side 171. Further, FIG. 5 shows an enlarged front elevation view of the means 95 for producing the perceptible output that is adjacent to the housing second end portion 165, wherein the means 95 shown in its entirety typically applies to apparatus 50 with a simplified version of the means 95 typically associated with apparatus 51.

Looking next to FIG. 5 is a preferred representation of the means 94 or 95 for producing a perceptible output in the form of a graphic “eye” preferred visual 135 display embodiment of the electrical test apparatus 50, note that means 95 is a reduced version of means 94 for utilizing a selected portion of the perceptible output, however, the preferences for means 94 and 95 are the same. The “eye” display 135 concisely presents about twenty three important information items in near real time. Indicators 590-592 are illuminated with measured nominal common power frequencies of 50, 60, and 400 Hz respectively. For other areas where uncommon power frequencies of 25 Hz for example, are easily added or substituted. Simultaneously display elements 530, 535, 536, 537, and 538 display measured frequency about the current nominal value.

Display is updated per table below at typically at 1 Hz.

### Frequency Update Table

| Element | Percent nominal | LED Indication Color |
|---|---|---|
| 536 | Nominal +/−0.05% | Green |
| 535 | Nominal −0.5 to 0.1% | Amber/yellow |
| 530 | Nominal less than 0.1% | Red |
| 537 | Nominal +0.5 to 0.1% | Amber/yellow |
| 538 | Nominal greater than 0.1% | Red |
| 538 | Nominal greater than 0.25% | Red flashing |
| 530 | Nominal less than 0.25% | Red flashing |

This function is particularly useful for solar inverter grid tie or frequency sensitive loads.

### Line Voltage Display

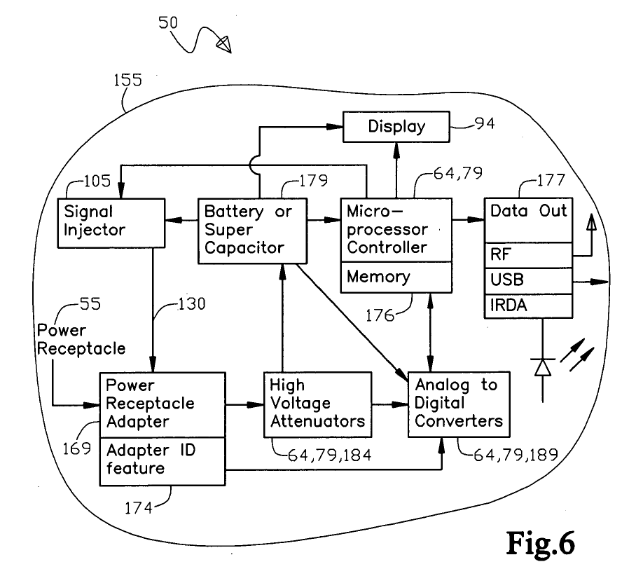

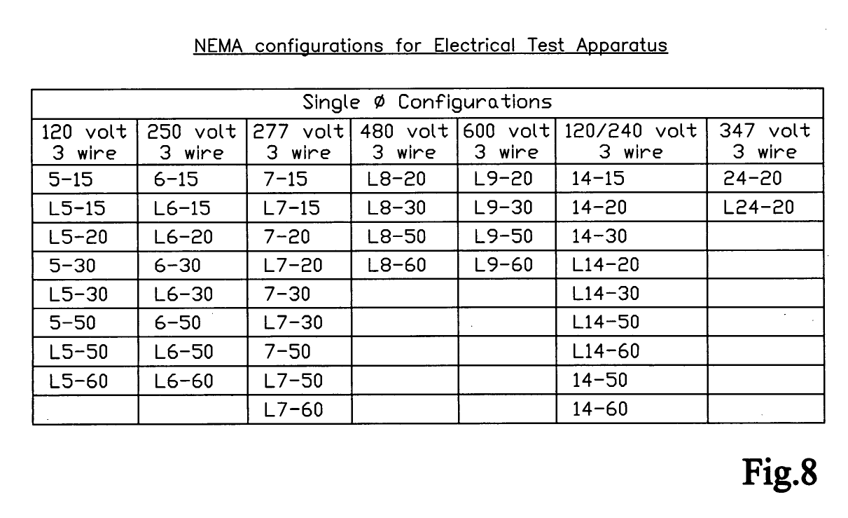

Similarly housing first end portion adaptor 160 in referring to FIG. 1, containing ID feature element 171 is read by processor, see FIG. 6 when connected to base unit housing 155. Nominal rated voltage range for connected housing first end portion adaptor 160 is read from a simple look-up table from FIG. 8 in memory 174 or 175, as shown in FIG. 6. Corresponding nominal line to neutral display element 552-558 is illuminated. For adaptors that operate over a range of voltages typically pin or prong 169 or 170 voltage is read via Analog/Digital Converter (ADC) 189 or 190 and circuitry attenuators 65, 80, and 184 or 185 and the closest nominal voltage indicator is illuminated. This feature advances the art as simple voltage indication devices don't discriminate in ambiguity with some power receptacles 55.

### Element Nominal Voltage Table

| | |
|---|---|
| 552 | 100 Vac |
| 553 | 115 Vac |
| 554 | 230 Vac |
| 555 | 360 Vac |
| 556 | 480 Vac |
| 557 | 600 Vac |
| 558 | out of range |

In near real time voltage on all active phases is continuously measured. Line to neutral displays 580 are updated per table below. Simultaneously line to line voltage indicators 570 are updated, per the same table with the nominal value differing by Sine (120 deg). Some delta circuits (three wires no neutral) detected by installed multiple prong connector adapter 169 or 170 first end housing portion 160 will automatically disable line to neutral display 580. Simultaneously rotation indicators 531 and 532 are updated if phase rotation is correct for three phase circuits. Using a conventional DMM requires 15 different measurements, interpreting readings, measurement selection, and probing a hard to reach potentially dangerous circuit. Further, a conventional DMM will not measure correct rotation, requiring a separate special meter. Visual display 135 of the means 95 can safely at a glance and without reading and interpreting seven moving numbers doing math and limit checking, gives an accurate status of twenty three key parameters at glance. For additional safety circuits 55 may be monitored and logged at a distance, i.e. remotely in near real time to a PDA/computer or like device. Odd circuit configurations such as two shorted phases will show the correct line to neutral reading, and may be missed with a cursory DMM check. However the line to line voltage 570 will read zero and is easily detected with the apparatus 50 without probing all the combinations with a typical DMM.

Line to Line (Line to Neutral Nominal*sine(120 deg))

| Element | Percent nominal | LED Indication Color |
|---|---|---|
| 510 | Nominal +/−4% | Green |
| 505 | Nominal −7% | Amber/yellow |
| 500 | Nominal less than 10% | Red |
| 506 | Nominal +7% | Amber/yellow |
| 501 | Nominal greater than 10% | Red |
| 501 | Nominal greater than 0.25% | Red flashing |
| 501 | Transient greater than 100% | Red Blue |
| 500 | Transient less than greater than 100% | Red Blue |

### Line to Neutral

| Element | percent nominal | LED Indication Color |
|---|---|---|
| 573 | Nominal +/−4% | Green |
| 574 | Nominal −7% | Amber/yellow |
| 575 | Nominal less than 10% | Red |
| 572 | Nominal +7% | Amber/yellow |
| 571 | Nominal greater than 10% | Red |
| 571 | Nominal greater than 0.25% | Red flashing |
| 575 | Transient greater than 100% | Red alternate Blue |
| 571 | Transient less than greater than 100% | Red alternate Blue |

### Neutral Ground Status

Indicator 540 indicates status of the neutral, green good, red open (when the multiple prong connector adaptor 169 or 170 has neutral pin) flashing red, neutral is “hot” i.e. greater than 50V. Indicator 541 indicates status of the ground, green good, red open (when the multiple prong connector adaptor 169 or 170 has ground pin) flashing red, ground is “hot” i.e. greater than 50V.

Numerical readings of the displayed parameters are logged to memory 174 or 175 with a time stamp. Simultaneously readings are formatted in a compact binary format and are optionally sent over wireless communications interface 173 to PDA or equivalent device. A wired optically isolated USB interface can also be supported for retrieving logged data and device configuration.

The present electrical test apparatus 50 or 51 invention helps to advance the state the circuit analyzer art with a compact and portable measurement tool that with quickly and safely connects to any standard circuit receptacle 56. The electrical test apparatus 50 or 51 performs in near real time about twenty three circuit measurements, being as an example for including but not limited to:

### Open Ground

### Hot Ground

High resistance Ground
Open neutral
Hot neutral
High resistance neutral

### Rotation

### Delta/wye Circuit

Nominal Line voltage

### A-Line to Neutral

### B-Line to Neutral

### C-Line to Neutral

A-C Line to line
A-B Line to line
B-C Line to line
A Low Line transient
B Low Line transient
C Low Line transient
A High Line transient
B High Line transient

Thus the electrical test apparatus 50 or 51 is a small rugged pocket sized unit that is easy to use and read by most any user, even a user with very limited electrical experience, plus records data to memory for later analysis and also can provide remote signal source port 215 for optional external circuit tracer 125.

Next, FIG. 6 shows a summary schematic or block diagram of the electrical test apparatus 50, further into FIG. 6 the block diagram depicts the primary functional elements of the electrical test apparatus 50. Starting with the receptacle 55 that is removably engaged to the multiple prong connector 169 or 170, wherein the multiple prong connector 169 or 170 are provided in various plug configurations, see FIG. 8 for some typical NEMA configurations to mate with all standard power receptacles 55 and thus provide plug-in electrical connection from the power receptacle 55 to the apparatus 50 modules 179 or 180, 184 or 185, and 189 or 190. The high voltage module 184 or 185 attenuates the high voltages from the power receptacle 55 to nominal voltage ranges which can be measured by the analog to digital converter 189 or 190. The high voltage module 184 or 185 also provides power to recharge the energy source battery or super cap 179 or 180, which powers the electrical test apparatus 50. The multi prong connector 169 or 170 also incorporates an identification feature 171 which may be a digital code read by the microprocessor or programmable chip 195, or resistor or voltage divider circuit which can be read by the analog to digital converters 189 or 190. The receptacle identification feature 171 provides information to the microprocessor 195 of what receptacle adapter is being used. This information is used in determining proper voltages and circuit connections of the specific receptacle 55.

Continuing in FIG. 6, the microprocessor 195 controls the sequential measurements of the typical National Electric Code (NEC) specified receptacle 55 parameters of voltage, connectivity, frequency, resistance, and phase rotation or as termed the criterion circuitry 80. Further there could be added structure to update the NEC for countries foreign to the United States. The measurement set for each corresponding power receptacle 55 is then compared in the microprocessor 195 with nominal values defined in memory according to the National Electrical Code (NEC) or other standards. This measurement set is then displayed on the preferably visual 135 read-at-a-glance display means 95 and also provided to the optional remote data out port 215 for transfer to a remote PDA or computer through a wired serial connection, or wirelessly through RF transmission 11, infra red data acquisition (IRDA), or any other communication medium. Special software running in the remote display module, PDA, or computer further processes the measurement data to display in a number of different graphical or alphanumeric formats including a digital oscilloscope and time-stamped data logger applications. Higher and/or lower frequency carrier current signals are generated in 105, which can either integral or remote to the apparatus 50. These carrier signals are uniquely coded for each wire of the power receptacle 55 and injected onto the individual power lines for circuit tracing using a separate “sniffer” receiver unit or for testing X-10 or equivalent carrier current control modules.

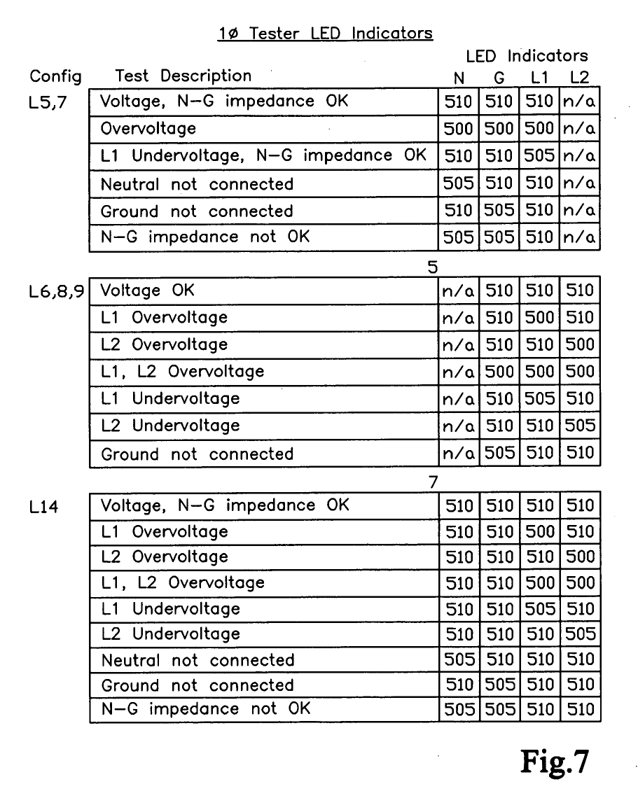

Next, FIG. 7 applies to the apparatus 51 and shows an indicator table of the perceptible output means 95 that is preferably simplified in the form of a plurality of lights 140 for the visual display 135 in LED color indications 145 for various electrical test conditions and FIG. 8 as applied to apparatus 50 or 51 shows a table of the National Electrical Manufacturers Association (NEMA) configurations for the electrical test apparatus 50 for the single phase configurations. Continuing, FIG. 9 as applied to apparatus 51 shows a detailed schematic of primarily the high voltage module 184 or 185 with the multi prong connector 169 or 170 interface with fuses, resistors, diodes, and associated circuitry, also interconnect 300 shows the electrical communication from FIG. 9 to FIG. 11, and FIG. 10 also as applied to apparatus 51 shows a detailed schematic of the power input circuitry 220, also with interconnect 305 showing the electrical communication from FIG. 10 to FIG. 11. The power input circuitry 220 is preferably constructed of a main component power module by Hirose model DF11G-8DP-2V(50) or equivalent. Further, FIG. 11 again as applied to apparatus 51 shows a detailed schematic of the analytical circuitry 65, the criterion circuitry 80, and the means 95 for perceptible output and FIG. 12 also applied to apparatus 51 shows a detailed schematic of the energy power circuitry 179 or 180, with interconnect 310 showing the electrical communication from FIG. 11 to 12.

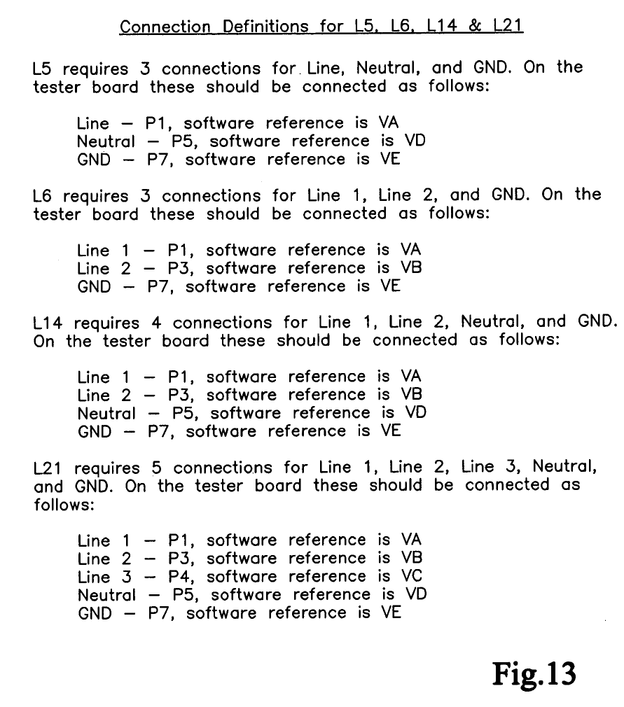

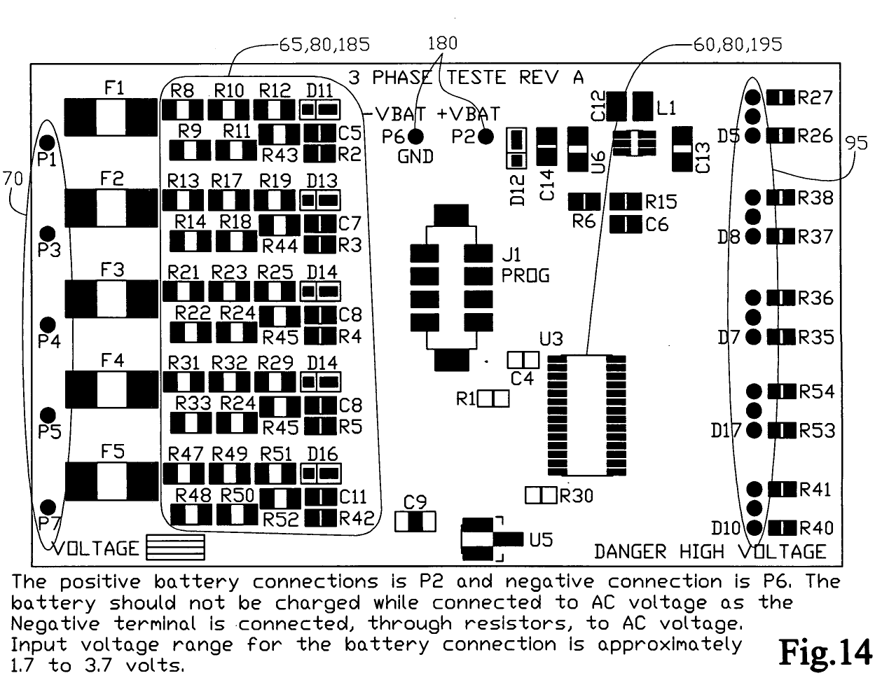

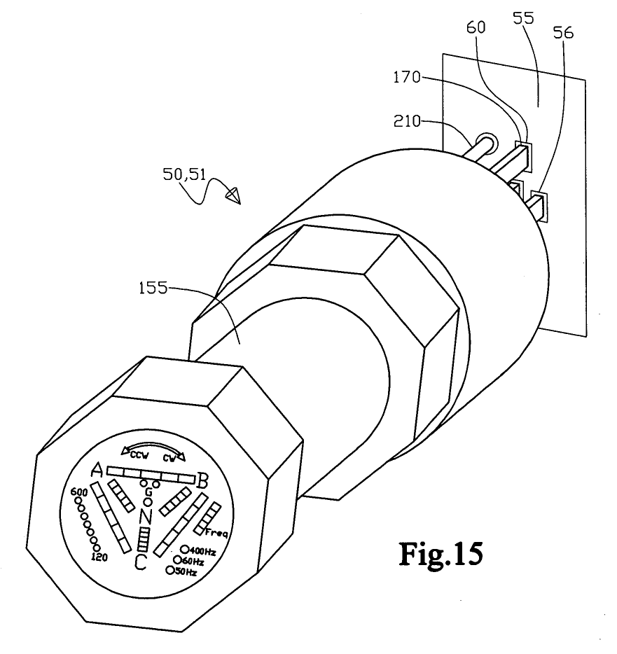

Continuing further, FIG. 13 further as applied to apparatus 51 shows a table of the connection definitions for NEMA test sequences L5, L6, L14, and L21, FIG. 14 also as applied to apparatus 51 shows a printed circuit board layout portion of the electrical test apparatus, and FIG. 15 shows a perspective in use view of the electrical test apparatus 50 with the multiple prong connector 169 or 170 partially removably engaged 50 to the electrical power receptacle 56 for pictorial clarity, note also that the housing 155 with a simplified display means 95 as previously described is applied to the alternative embodiment 51 is shown. Next, FIG. 8 as applied to apparatus 50 or 51 shows a table of the National Electrical Manufacturers Association (NEMA) configurations for the electrical test apparatus 50 for the three phase configurations.

Broadly the present invention of the electrical test apparatus 50 or 51 is adapted to be removably engaged 60 and in electrical communication 60 with an electrical power terminal 55, which could be a wire cable connection or any other equivalent, as best shown in FIG. 15 being preferably a portable and handheld apparatus 50 that broadly includes analytical circuitry 64 or 65 that is operative in each of a plurality of modes 70 to monitor the electrical power terminal 55 and produce a plurality of event marker signals 75. Further included in the electrical test apparatus 50 or 51 is a criterion circuitry 79 or 80 that is operative in each of the aforementioned plurality of modes 70 to receive each of the plurality of event marker signals 75 for a comparison with a selected value 85 for each of the plurality of modes 70, wherein the criterion circuitry 79 or 80 outputs a plurality of indicator signals 90 each corresponding to one of the plurality of modes 70, see summary the schematic in FIG. 6 for apparatus 50 and the detailed schematics in FIGS. 9 to 12, for apparatus 51 and FIG. 14 for the printed circuit board assembly applying to apparatus 51. Also included in the electrical test apparatus 50 or 51 is a means 94 or 95 for producing an associated perceptible output in response to each of the plurality of indicator signals 90.

To further define the preferred plurality of modes 70, several groupings are defined starting with a selection from the group consisting essentially of voltages 100 and frequencies 105, wherein the criterion circuitry 80, wherein the criterion may be programmed into memory 174 or 175, has selected ranges for acceptability thus giving the perceptible output means 95 an integer type output such that the reading from the output is determined as a pass/fail type of indication resulting in a quick and easy electrical test that can be conducted by a lay person with very limited experience. Wherein a quick indication is provided of failure mode relative to a specified criterion for the user. Thus, the criterion circuitry 80 would for instance have a selected range of acceptable voltages based upon the type of multiple prong connector 169 or 170 style, see FIG. 8 for suggested NEMA multiple prong connector styles. Wherein the indicator signals 90 from the criterion circuitry 80 will illuminate specific lights 140 of the means 94 or 95 for the perceptible indication of the particular mode pass/fail test, see FIG. 5 for the best detail for the means 94 or 95.

Continuing on the preferred modes 70 for the electrical test apparatus 50 or 51 another option is selected from the group consisting essentially of three phase circuit rotations 110, ground conditions 115, and neutral conditions 120, see FIG. 5 for perceptible output means 94 or 95 preferred detail. Next, another preferred mode 70 grouping for the electrical test apparatus 50 or 51 from the group consisting essentially of a circuit tracers 125 and frequency signals 130, again see FIG. 5 for indication detail. Note that any other combination of modes 70 could be utilized as differentiated from what was previously disclosed, i.e. voltage 100 could be grouped with neutral conditions 120, or ground conditions 115 could be grouped with frequencies 105, and so on.

Continuing on the detail for the means 94 or 95 for perceptible output is preferably a visual display 135 with the previously described pass/fail orientation for a quick and easy circuit status indication by even the least experienced in electrical and power individual, see FIGS. 1 through 3, and FIG. 5 in particular, also see schematics in FIGS. 11 and 14. Continuing on the preferred detail for the means 94 or 95 for the electrical test apparatus 50 or 51 the visual display 135 is adapted to vary its display in response to a selected one of the indicator signals 90, as best shown in FIG. 5, wherein the display is preferably varied in an integer or on/off indication for the quick easy test result indication as previously described, thus for user simplicity all lights 145 being a green 510 indication signifies a pass for the receptacle 56. Also, on the means 94 or 95 for perceptible output, the visual display 135 preferably includes a plurality of lights 140, with each of the lights being in electrical communication with a corresponding one of the plurality of indicator signals 90 and in addition preferably each of the lights 140 is a unique color 145 that is operational to allow for a instant perception of the electrical test result as previously described, see FIG. 5 for the display portion and FIG. 7 for a table of typical test indicators related to color as indicated as element numbers 500 through 575. Preferably the lights 140 are Panasonic model dual LED LN11WP23 or equivalent. In particular reference to FIG. 5, note that the visual display 135 is intuitively arranged in the “Y” or Delta “Triangle” to graphically define the measurement parameter such as line to line voltage, frequency, phase rotation, ground, neutral, and the like. Graphical bars with different color indications 145 represent for example voltage between line A and line B, also for instance line A to ground or neutral, again to make the receptacle 55 test as easy and quick as possible by an untrained user. Another option on the electrical test apparatus 50 or 51 for the means 94 or 95 for the perceptible output is a selected audible perception 150 in response to each of the plurality of indicator signals 90, wherein the audible perception 150 can be a horn, buzzer, siren, or any other audible perception that can vary or be constant in decibels and/or frequency.

Back to the electrical test apparatus 50 or 51 alternatively the analytical circuitry 65, criterion circuitry 80, and the means 95 for producing an associated perceptible output are all disposed within a housing 155, as best shown in FIGS. 1 through 4 and FIG. 15. Note that the housing 155 may be constructed of a number of different materials; however, preferably a composite would be utilized that is a poor electrical conductor and is weatherproof; also the housing 155 may assume a number of different shapes. Also the housing 155 may be of integral one-piece construction, as shown in FIG. 1, or be segmented into multiple piece construction as shown in FIGS. 2 and 3, for the purpose of separable housing 155 pieces for different multiple prong connectors 169 or 170 or remote porting segments 172. Continuing on the housing 155 for the electrical test apparatus 50 wherein said housing has a first end portion and a second end portion, said first end portion is adjacent to a multiple prong connector that is removably engagable and in electrical communication with an electrical receptacle and said second end portion is adjacent to said means 94 or 95 for producing an associated perceptible output.

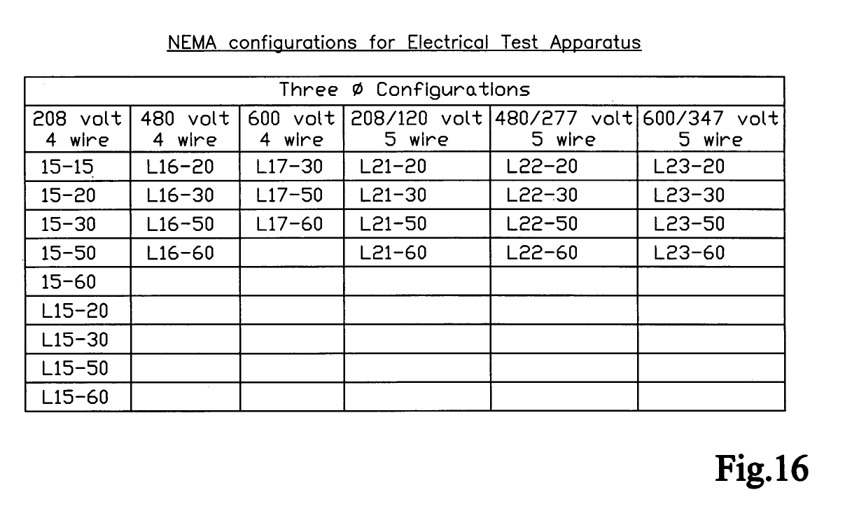

Moving in detail on the multiple prong connector 169 or 170 for the electrical test apparatus 50 or 51 the multiple prong connector 169 or 170 is preferably a plurality of unique multiple prong groups 200, see FIGS. 8 and 16 for typical examples of the NEMA prong connectors, wherein each multiple prong group is associated with the criterion circuitry 80, which may be programmable into memory 174 or 175, with the criterion having an acceptable selected range of acceptable electrical performance defined by each unique multiple prong group, as defined for voltages, phase number, current, and the like with FIGS. 8 and 16 as examples that associate a unique multiple prong configuration with a specific voltage, current, and phase number. Other unique multiple prong connector 169 or 170 arrangements could be utilized also that are outside of FIG. 8 in scope that associated a specific multiple prong connector 169 or 170 with various electrical particulars, i.e. voltage, frequency, phase number and so on. As a further option for the multiple prong connector 169 or 170 for the electrical test apparatus 50 the multiple prong connector 169 or 170 can be a pin and sleeve type 205, as shown in FIG. 4 and FIG. 15 in use.

Another optional feature for the electrical test apparatus 50 or 51 concerns the housing 155 wherein the first end portion 160 further comprises a means 210 for electrical test apparatus activation/deactivation that is operational based upon proximity of the first end portion 160 to the electrical receptacle 56 as best shown in FIG. 15. Preferably the means 210 is a contact switch that activates the electrical test apparatus 50 when the multiple prong connector 169 or 170 is fully inserted into the electrical receptacle 56 to preserve the energy source 179 or 180 from being activated when the electrical test apparatus 50 multiple prong connector 169 or 170 is not inserted into the electrical receptacle 56. Further the means 210 could be other structures for accomplishing the objective of activating/deactivating the electrical test apparatus 50 when the multiple prong connector 169 or 170 is proximate to the electrical receptacle 56 such as infrared sensor, laser, and the like. Further, as an option the apparatus 50 or 51 can be powered from the receptacle 56 when the prong connector 169 or 170 is removably engaged and in electrical communication with the receptacle 56 thus eliminating the need for the means 210 to activate/deactivate the apparatus 50 or 51 independently as previously discussed, in addition the apparatus 50 or 51 can provide a “null” indication (no lights 140) if no power is present at the receptacle 56 under this option.

As an additional enhancement the electrical test apparatus 50 or 51 can include logging circuitry 174 or 175 that is operational to store cumulative data from the event marker signals 75 or the indicator signals 90. The cumulative data can be put forth on means 94 or 95 for perceptible output either locally adjacent to the housing 155 or remotely via means 173 for a remote perceptible output. The means 173 is preferably a port 215 as best shown in FIG. 3, which can be a USB, RCA, DVI, VGA, or any other remote electrical communication, further alternatively means 173 could be wireless data transmission of any type. Further, enhancement on the electrical test apparatus 50 or 51 could include on the criterion circuitry 80 that can be operative in each of the plurality of modes 70 that include circuit tracers mode 125 and frequency signals mode 130 to also inject a frequency signal into the electrical receptacle 56, using an integral or remote circuit tracer to follow the electrical communication from the electrical receptacle 56.

The electrical test apparatus 50 or 51 includes the multiple prong connector 169 or 170, the analytical circuitry 65, the criterion circuitry 80 and a means 95 for perception. Wherein the analytical circuitry 65 and the criterion circuitry 80 are typically embodied in a programmable chip 195 that further includes the analog/digital converter 189 or 190 that is preferably a Texas Instruments MSP430F1222IPW or equivalent. There may also be provisions to plug in leads in the port 215 for a conventional volt meter or multi-meter. The multiple prong connector 169 or 170 has a plurality of electrically conductive blades configured to mate into one or more types of power receptacles 56. Further, the multiple prong connectors 169 or 170 may be constructed in a variety of blade configurations that matingly engage with the different types of power receptacles 56 including but not limited to two-prong, three-prong, four-prong, and five-prong receptacles for single-phase and three-phase power circuits. The multiple prong connectors 169 or 170 can include an electrical socket connector adapter 171 made up of a plurality of electrical socket contacts some of which are in electrical communication with each of the plug-in blade contacts of the multiple prong connector 169 or 170. The electrical socket connector adapter 171 of the plug-in adapter makes electrical contact when a mating male connector on the analyzer circuitry 65/criterion circuitry 80 portion of the electrical test apparatus 50 disposed within the housing 155 is plugged into it, as shown in FIG. 2. One or more of the electrical socket connector contacts on the electrical socket connector adapter 171 and the mating connector on the apparatus housing 155 may be used to provide information to the apparatus 50 as to the type of multiple prong connector 169 or 170 it is mated to. This identifying information may be produced electrically in the form of a memory chip, or a value of capacitance, resistance or inductance that can be measured by the apparatus 50 or 51 thus defining the exact configuration of the multiple prong connector 169 or 170 being used, in so far as voltage, current, frequency, number of phases, and the like. Alternatively the identifying information of the multiple prong connector 169 or 170 may be transferred to the apparatus 50 wirelessly through an optical, magnetic, RF, or alternative communication link.

The analyzer portion of the electrical test apparatus 50 or 51 includes electrical circuitry, namely the analytical circuitry 65 and the criterion circuitry 80 which may include a microprocessor programmable chip 195, and digital to analog converter circuits 189 or 190 to measure voltages between the blades of the multiple prong connector 169 or 170 as it is electrically communicated through the adaptor, which electrically connects between the plug-in adapter 171 and the analyzer section from the electrical receptacle 56. In one embodiment, the microprocessor 195 controls the measurements of all the voltages, the frequency, and the resistance from neutral to ground at the corresponding blade or prong 169 or 170 connections. Measurements may be taken to capture power events such as power line voltage spikes, intermittent blackout or brown out conditions. From this analysis the microprocessor 195 circuit thereby determines if the power circuit is wired correctly or not, and if the power at the blade or prong 169 or 170 terminals are proper for the particular receptacle 56 that the electrical test apparatus 50 is plugged into as well as information on the condition of the available power at the electrical receptacle 56. This information is then displayed on a visual display 135 panel connected to the microprocessor, as shown in FIGS. 1, 2, 3, and 5.

In another embodiment the visual display 135 is made up of a custom array of colored LED's 140 or other illuminating elements that provide a nominal, high, low, or other anomaly indication at a glance without the need for the user to read and interpret multiple voltage readings and frequency measurements, wiring, and condition indications. In an alternative embodiment of the electrical test apparatus 50 or 51 the digital measurements may be stored and displayed on an alphanumeric display 135 or the “read at a glance display” and can be read by the user even after unplugging the apparatus 50 or 51 from the receptacle 56. In yet another alternative embodiment, the electrical test apparatus 50 or 51 measurement signals 75 or 90 may be transmitted from the apparatus 50 to be remotely received and displayed on a hand held receiver unit, PDA, computer or other wired or wirelessly connected device. The communication link for this may be a wired connection, an optical, an rf, or any other communication link. Optional software, which accompanies one embodiment of this invention, may be used to display continuous measurements transmitted from the electrical test apparatus 50 or 51 to the screen of a PDA, computer, or the like, thus performing a function similar to a digital oscilloscope.

In yet another embodiment of the electrical test apparatus 50 or 51, it may remain plugged into a power receptacle 56 for a period of time to monitor the power over time and to capture intermittent or erratic power conditions such as voltage spikes, momentary black outs or brown out conditions. In this embodiment the apparatus 50 acts as a data logger utilizing the logging circuitry 174 or 175 capturing the anomalous condition measurement and time to be displayed later anywhere it is convenient for the user as previously discussed.

In yet another alternative embodiment of the apparatus 50 or 51 the circuitry may inject a carrier current signal 130 for frequency signal injector 105 onto any conductor blade prong 169 or 170 of the receptacle 56 it is plugged into. A separate receiver or “sniffer” unit that detects the carrier current signals is optionally supplied to allow the user to easily “trace” the specific conductor or wire, or identify the tagged circuit at the breaker or fuse panel from the receptacle 56. In another alternative embodiment of the electrical test apparatus 50, a user activated push button or switch contact is provided on the apparatus 50 to test a ground fault circuit interrupter GFCI. In yet another alternative embodiment, the plug-in portion adapter 171 of the apparatus 50 or 51 may be integral to the apparatus 50 or 51 housing 155 portion.

### CONCLUSION

Accordingly, the present invention of an electrical test apparatus has been described with some degree of particularity directed to the embodiments of the present invention. It should be appreciated, though, that the present invention is defined by the following claims construed in light of the prior art so modifications the changes may be made to the exemplary embodiments of the present invention without departing from the inventive concepts contained therein.

1. An electrical test apparatus that is adapted to be removably engaged and in electrical communication with an electrical power terminal, said electrical test apparatus comprising:
(a) analytical circuitry operative in each of a plurality of modes to monitor the electrical power terminal and produce a plurality of event marker signals;
(b) criterion circuitry operative in each of said plurality of modes to receive each of said plurality of event marker signals for a comparison with a selected value for each of said plurality of modes, wherein said criterion circuitry outputs a plurality of indicator signals each corresponding to one of said plurality of modes; and
(c) a means for producing an associated perceptible output in response to each of said plurality of indicator signals.

2. An electrical test apparatus according to claim 1 wherein said plurality of modes is selected from the group consisting essentially of voltages and frequencies.

3. An electrical test apparatus according to claim 1 wherein said plurality of modes is selected from the group consisting essentially of three phase circuit rotations, ground conditions, and neutral conditions.

4. An electrical test apparatus according to claim 1 wherein said plurality of modes is selected from the group consisting essentially of a circuit tracer and a frequency signal.

5. An electrical test apparatus according to claim 1 wherein said means for producing an associated perceptible output is a visual display.

6. An electrical test apparatus according to claim 5 wherein said visual display is adapted to vary its display in response to a selected one of said indicator signals.

7. An electrical test apparatus according to claim 5 wherein said visual display includes a plurality of lights, each of said lights being in electrical communication with a corresponding one of said plurality of indicator signals.

8. An electrical test apparatus according to claim 7 wherein each of said lights is a unique color that is operational to allow for an instant perception of an electrical test result.

9. An electrical test apparatus according to claim 1 wherein said means for producing an associated perceptible output is a selected audible perception in response to each of said plurality of indicator signals.

10. An electrical test apparatus according to claim 1 wherein said analytical circuitry, said criterion circuitry, and said means for producing an associated perceptible output are all disposed within a housing.

11. An electrical test apparatus according to claim 10 wherein said housing has a first end portion and a second end portion, said first end portion is adjacent to a multiple prong connector that is removably engagable and in electrical communication with an electrical receptacle and said second end portion is adjacent to said means for producing an associated perceptible output.

12. An electrical test apparatus according to claim 11 wherein said multiple prong connector is a plurality of unique multiple prong groups wherein each multiple prong group is associated with said criterion circuitry having an acceptable selected range defined by each said unique multiple prong group.

13. An electrical test apparatus according to claim 11 wherein said multiple prong connector is a pin and sleeve type.

14. An electrical test apparatus according to claim 11 wherein said first end portion further comprises a means for electrical test apparatus activation/deactivation that is operational based upon proximity of said first end portion to said electrical receptacle.

15. An electrical test apparatus according to claim 1 further comprising logging circuitry that is operational to store cumulative data from said event marker signals.

16. An electrical test apparatus according to claim 1 further comprising logging circuitry that is operational to store cumulative data from said indicator signals.

17. An electrical test apparatus that is adapted to be removably engaged and in electrical communication with an electrical power terminal, said electrical test apparatus comprising:
(a) analytical circuitry operative in each of a plurality of modes that include voltages, frequencies, three phase circuit rotations, ground conditions, and neutral conditions to monitor the electrical power terminal and produce a plurality of event marker signals;
(b) criterion circuitry operative in each of said plurality of modes that include voltages, frequencies, three phase circuit rotations, ground conditions, and neutral conditions to receive each of said plurality of event marker signals for a comparison with a selected value for each of said plurality of modes, wherein said criterion circuitry outputs a plurality of indicator signals each corresponding to one of said plurality of modes; and
(c) a means for producing an associated perceptible output in response to each of said plurality of indicator signals.

18. An electrical test apparatus according to claim 17 wherein said means for producing an associated perceptible output is a visual display, wherein said visual display is adapted to vary its display in response to a selected one of said indicator signals.

19. An electrical test apparatus according to claim 17 further comprising logging circuitry that is operational to store cumulative data from said event marker signals or said indicator signals.

20. An electrical test apparatus that is adapted to be removably engaged and in electrical communication with an electrical power terminal, said electrical test apparatus comprising:
(a) analytical circuitry operative in each of a plurality of modes that include a circuit tracer and a frequency signals to monitor the electrical power terminal and produce a plurality of event marker signals;
(b) criterion circuitry operative in each of said plurality of modes that include a circuit tracer and a frequency signal to receive each of said plurality of event marker signals for a comparison with a selected value for each of said plurality of modes, wherein said criterion circuitry outputs a plurality of indicator signals each corresponding to one of said plurality of modes; and
(c) a means for producing an associated perceptible output in response to each of said plurality of indicator signals.

21. An electrical test apparatus according to claim 20 wherein said means for producing an associated perceptible output is a visual display, wherein said visual display is adapted to vary its display in response to a selected one of said indicator signals.

22. An electrical test apparatus according to claim 20 further comprising logging circuitry that is operational to store cumulative data from said event marker signals or said indicator signals.

23. An electrical test apparatus according to claim 20 further comprising a means for a remote perceptible output.
